(19) United States
(12) Patent Application Publication
(10) Pub. No.: US 2003/0188833 A1
(43) Pub. Date: Oct. 9, 2003

(54) Floor covering removal tool

(76) Inventor: George Kenneth Adleman Jr, Loma, CO (US)

Correspondence Address: CHRISTIE, PARKER & HALE, LLP, 350 WEST COLORADO BOULEVARD, SUITE 500, PASADENA, CA, 91105, US

(21) Appl. No.: 10/344,012

(22) PCT Filed: Jun. 8, 2001
(86) PCT No.: PCT/US01/18567

(51) Int. Cl. B32B 35/00

(52) U.S. Cl. 156/584

(57) ABSTRACT

A floor cover removal tool having a rigid roller (1) of substantially cylindrical shape with an internal clamp (11) for holding the end of the floor covering being removed.

### FIELD OF THE INVENTION

This invention relates to the removal of floor covering, such as, e.g., carpet or vinyl, adhesively secured to a substrate of a floor or stairs and more particularly to a rugged, easy to use tool for removing the floor covering.

### BACKGROUND OF THE INVENTION

Floor covering, such as carpet or vinyl, is often glued to a substrate such as wood or concrete. The removal of floor covering and particularly carpet adhesively secured to a substrate has been addressed in a number of U.S. patents. Various devices or tools have been disclosed and are in use today. These devices tend to be bulky, expensive and often take considerable time to set up for operation.

The following U.S. patents disclose various devices for removal of adhesively secured floor covering: U.S. Pat. Nos. 4,332,371, 4,394,052, 4,533,118, 4,560,146, 4,906,323, 4,948,451, 5,348,608, 5,387,308, 5,454,899, 5,456,794, 5,505,433, 5,720,844, and 6,004,426.

At least two of these patents disclose a carpet removal device where the removed carpet is rolled up on a spool. In U.S. Pat. No. 4,394,052 ('052 patent) the carpet removal. device includes a blade that is pulled forward under the carpet being removed to wedge beneath the carpet to separate the carpet from the floor. In one embodiment, the winding of the carpet up on the spool causes the device to move forward to wedge the knife beneath the carpet. A free end of the carpet is attached to the spool. (The method of attaching is not disclosed). The spool has four longitudinal bars or spool crossbars on which the carpet is wound.

The device of the '052 patent is relatively heavy, cumbersome and expensive. Also it has been found that the blade of carpet removal devices digs into the substrate and gets stuck in wooden substrate. Additionally, these blades do not stay sharp in use. A further problem with bulky devices, such as the one disclosed in the '052 patent is that they require a large area in which to maneuver. Also, these devices are not useful in removing floor covering from stairs or confined areas.

Other devices employing a spool are disclosed in U.S. Pat. No. 6,004,426 ('426 patent). A blade is not used in the devices of the '426 patent and the carpet is pulled up by being wound on a rotating spool. The end or edge of the carpet to be removed is attached to the spool. In the preferred embodiment the means for attaching the edge of the carpet to the spool member is a plurality of tooth members extending outwardly from the spool member that are laterally aligned between the ends of the spool member to form a row of tooth members. Other means for attaching the edge of the carpet to the spool member are disclosed. The other means for attaching include a relatively strong tape, clips attached to the spool member, and tapped holes in the outer surface of the spool member through which sharpened screws can be cooperatively inserted after penetrating a portion of the carpet, with the screws holding the floor covering to the spool member.

The preferred means for attachment of the '426 patent has many problems in practice. A first problem is one of safety in that the sharp and pointed teeth can tear up the hands of the user. Additionally, it has been found that the teeth break off because of the torque that occurs in pulling up the carpet while rolling it on the spool.

### SUMMARY OF THE INVENTION

The problems of the prior devices for removing floor covering, such as carpet or vinyl, adhesively secured to a floor or stairs are overcome by the simple tool of the invention. The tool consists of a cylindrical roller formed from two parts that are hinged together and that have an opening or slit through which the end of the floor covering is inserted. A member attached to the inside surface of one part pushes the floor covering against a similar member attached to the inside surface of the other part or against the inside surface of the other part to hold the floor covering in place while rotating the roller to take up the floor covering. Alternatively, a member carried by one part pushes the end of the floor covering against a member carried by the other part.

The roller is made of relatively heavy material to give the cylindrical body of the tool rigidity and to provide a secure grip on the end of the floor covering in the initial stages of pulling up the floor covering and rolling it on the roller.

The roller may be manually rotated or rotated by a motor. For rotation, a coupler extends from one or both ends of the cylindrical portion of the roller. The coupler has a shaped hole for receiving a correspondingly shaped shaft of the drive mechanism. For manual rotation, a lever arm has a shaft extending at a right angle at one end to engage the coupler of the roller. Advantageously, the same end of the lever arm includes a ratcheting mechanism for ratcheting the arm back into a position to further rotate the roller of the tool.

Alternatively, a motor drive with an adaptor at the end of the motor shaft to accommodate the shape and depth of the coupler at the end of the roller may be employed. The motor has a carriage that is placed under the motor to carry the motor as it moves while rotating the roller of the tool. The carriage is attachable to either side of the motor for rotation of the tool in either direction.

In operation, the roller makes several complete revolutions and has a plurality of layers of floor covering rolled onto the roller. The floor covering is cut next to the roller and the cut end of the floor covering on the roller is held while the roller with the layers of floor covering is rolled to unroll the floor covering to remove it from the roller.

The unrolling of the floor covering to remove it from the roller to make the roller available to begin the removal of additional floor covering is a time-consuming step.

The roller is modified to eliminate the step of unrolling the removed floor covering. An adjustable spacer device is attached to the interior of the roller to adjust the diameter of the roller from a large size while removing and rolling the floor covering onto the roller to a smaller diameter that permits removal of the roller from the rolled up floor covering. One device providing the two diameters of roller includes a set of spacer teeth having a first row of teeth that is movable relative to a second row of teeth. The teeth are adjusted to provide the larger diameter during removal and rolling of the floor covering onto the roller. The smaller diameter is provided to permit removal of the roller from the rolled up floor covering by moving one set of teeth relative to the other so that the teeth mesh rather than sitting one row on top of the other. In this way the diameter is reduced.

Once the floor covering is rolled onto the roller to the desired number of layers or possibly to the point where it is too difficult or takes too much energy to roll additional floor covering, the floor covering is cut to leave a sufficient length of pulled-up floor covering for insertion into and gripping by the roller to begin the removal of the next strip of floor covering. The roller with its layers of floor covering is then free from the floor covering on the floor. At this time, a knife is used to cut the floor covering near the point where it enters the roller and before the point where the end of the floor covering in the roller is gripped. This knife may be positioned in the roller before removing the floor covering from the floor and rolling it onto the roller. Such a knife is pulled out of the roller to cut the floor covering. Alternatively, a knife may be pushed through the roller near the opening where the floor covering is inserted to cut the floor covering.

Once the floor covering has been cut, one row of teeth of the spacer teeth is caused to move and mesh with the other row of teeth to reduce the diameter of the roller. The roller is then small enough to be pushed and/or pulled out of the center area of the rolled layers of floor covering.

Objects, features and advantages of this invention will become apparent from a consideration of the description, the appended claims and the accompanying drawing.

### BRIEF DESCRIPTION OF THE DRAWINGS

FIG. 1 a top plan view of the roller of the floor covering removal tool in a fully closed position in accordance with this invention;

FIG. 2 a bottom plan view of the roller in a fully closed position in accordance with this invention;

FIG. 3 is a left end elevation view of the roller of FIG. 1 in accordance with this invention;

FIG. 4 is a top plan view of the roller of the floor covering removal tool in a fully open position in accordance with this invention;

FIG. 5 is a bottom plan view of the roller in a fully open position in accordance with this invention;

FIG. 6 is a left end elevation view of the roller of FIG. 4 in accordance with this invention;

FIG. 7 is a cross-sectional view of the roller along the section lines 7-7 of FIG. 1 in accordance with this invention;

FIG. 7A is a cross-sectional view of an alternative embodiment of a roller wherein one part of the cylindrical body is larger than the other part of the cylindrical body in accordance with this invention.

FIG. 8 is a cross-sectional view of the roller along section line 7-7 of FIG. 1 with an end of floor covering to be removed locked in place in accordance with this invention;

FIG. 9 is a cross sectional view of the roller with rolls or layers of the removed floor covering on the roller in accordance with this invention;

FIG. 10 is a perspective view of the roller with an end of the floor covering locked in place and a drive mechanism having a ratcheted handle for turning the roller in accordance with this invention;

FIG. 11 is a front elevation view of the drive mechanism of FIG. 10 in accordance with this invention;

FIG. 12 is a left side elevation view of a motor and adaptor for driving the roller in accordance with this invention;

FIG. 13 is a top plan view of the motor and adaptor with a reversible roller carriage in accordance with this invention;

FIG. 14 is a front elevation view of the motor with a wheeled carriage in accordance with this invention;

FIG. 15 is a pulled apart perspective view of the motor, adaptor and roller positioned on a centerline for assembly in accordance with this invention;

FIG. 16 is a cross-sectional view through the longitudinal center of the roller of an alternative embodiment with another device for holding the end of the floor covering to be removed in accordance with this invention;

FIG. 17 is a cross-sectional view of a roller having an internal floor covering gripper that has a surface that corresponds to the internal surface of the roller;

FIG. 18 is a top plan view along the longitudinal line of the holding means of FIG. 17 showing a rough surface;

FIG. 19 is a perspective view from the left end of an alternative embodiment of a floor covering removal tool in accordance with this invention;

FIG. 20 is a front elevation view of the tool of FIG. 19;

FIG. 21 is a cross-section view along section lines 21-21 of FIG. 20;

FIG. 22 is a front elevation view partly in cross section along the section line 22-22 in FIG. 21;

FIG. 23 is a front elevation view partly in cross section similar to FIG. 22 with spacer teeth closed in accordance with this invention;

FIG. 24 is a perspective view of a portion of the roller and floor covering around the roller showing a knife cutting the floor covering;

FIG. 25 is a perspective view of a partial roller and floor covering showing a knife being pushed through the floor covering to cut the floor covering;

FIG. 26 is an end elevation view in cross section similar to FIG. 21 showing an alternative embodiment where the hinge is offset from a point diametrically opposite the opening in the roller.

### DESCRIPTION OF THE EMBODIMENTS

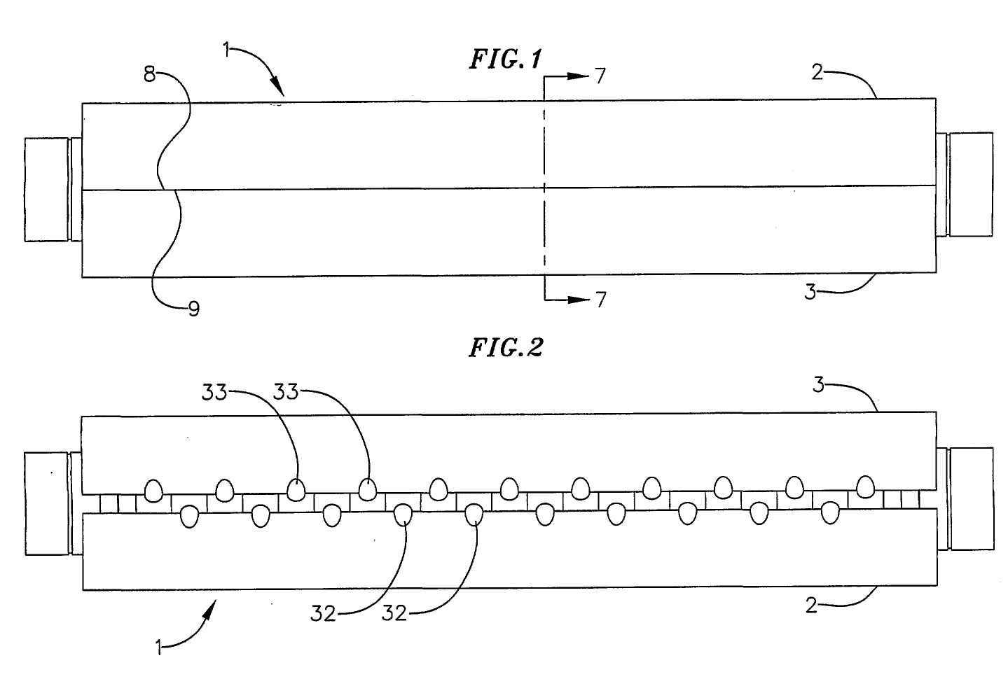

The roller 1 of the tool for removing floor covering, such as carpet, that has been adhesively attached to a substrate has a rigid body, preferably made of steel. The invention will be disclosed with carpet, but is also useful for removing vinyl. Roller 1 has a first part 2 and a second part 3 held together by a hinge 4. As seen best in FIGS. 4-7, part 2 and part 3 are essentially half cylinders joined along edge 5 and edge 6, respectively, by hinge 4 and form a substantially cylindrical body when closed together. When fully closed, as shown in FIGS. 1-3 and 7, edge 8 of the first part 2 and edge 9 of the second part meet in a line 7 that is diametrically opposite the hinge 4. An opening 10 between parts 2 and 3 along the edges 8 and 9 is formed when the parts are opened for insertion of the end of the floor covering.

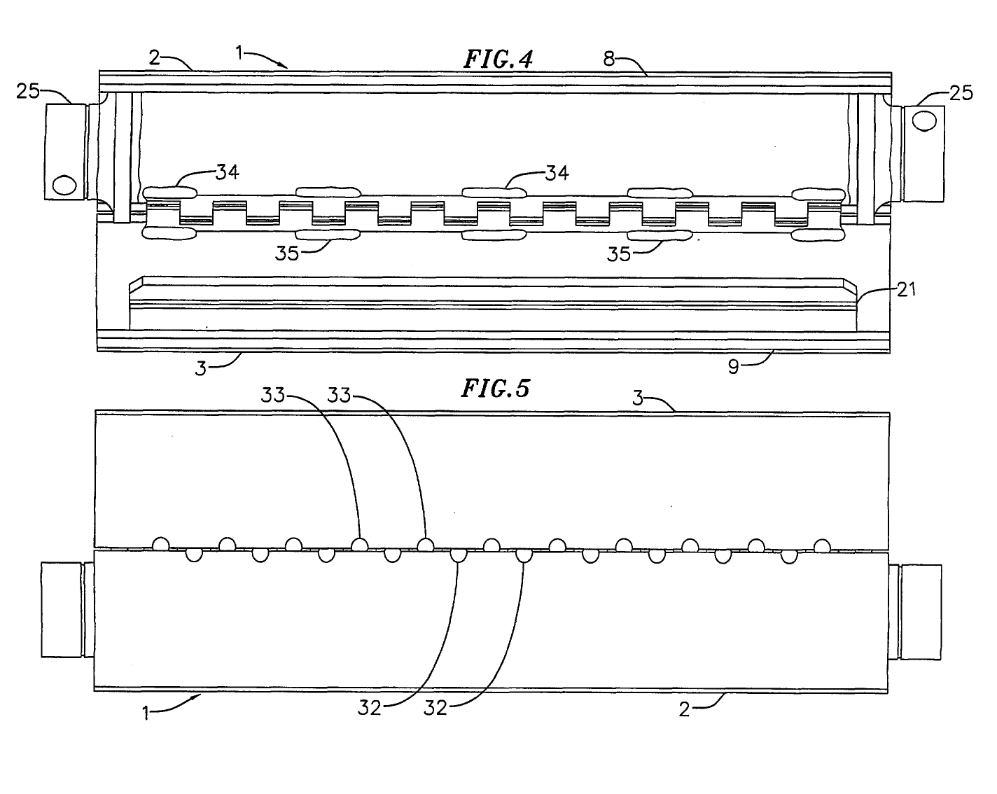

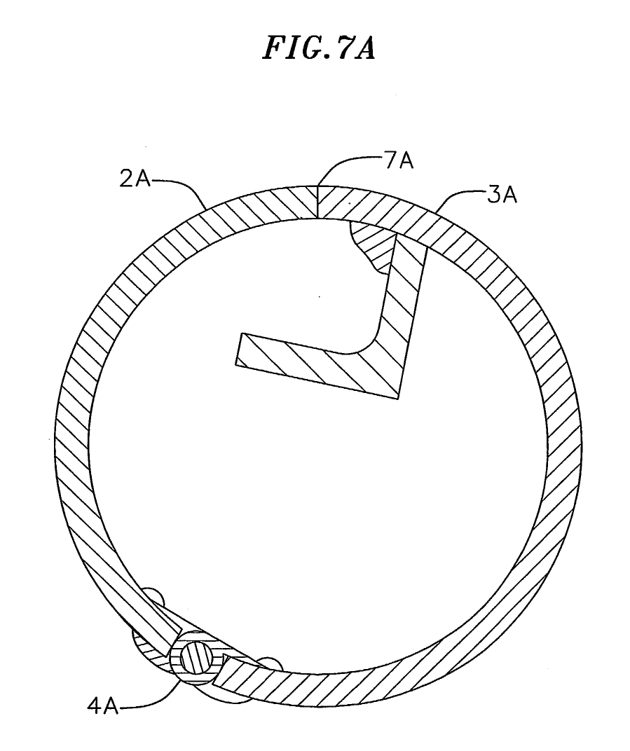

In the embodiment of the drawings, the two parts joined by a hinge are identical. Each is essentially a half cylinder. Alternatively, one part 2A may be larger than the other part 3A and the greater part of the cylinder as shown in FIG. 7A. The hinge 4A joining the parts will then not be diametrically opposite the opening where the end of the floor covering is inserted as shown in FIG. 7A.

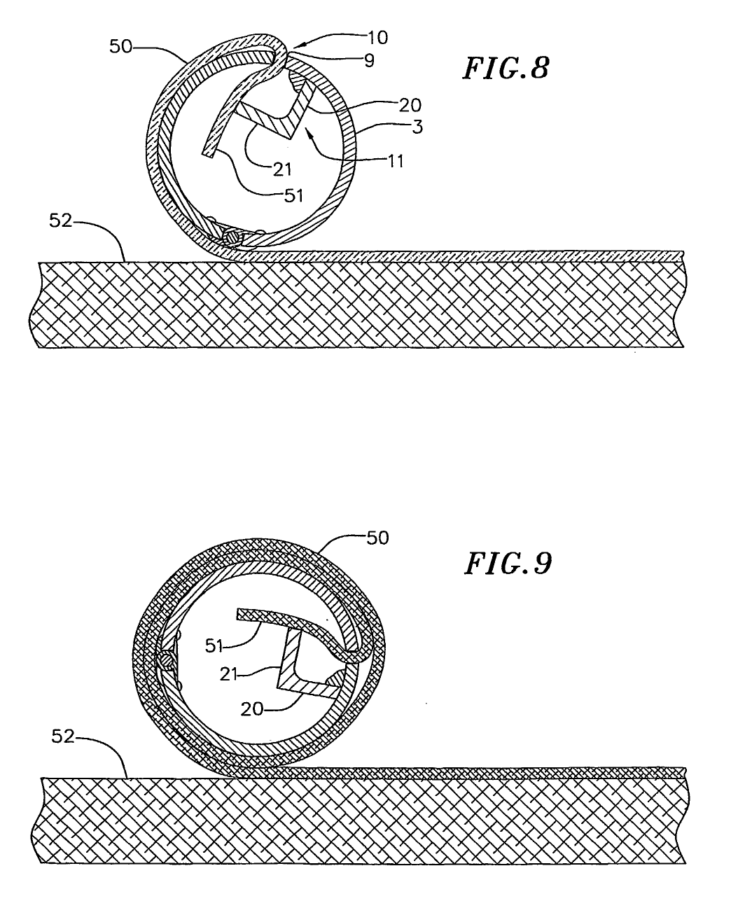

The roller 1 has an internal means for gripping or holding the end of the floor covering in place while it is being rolled on the roller 1. As shown in FIG. 8 the second part has a longitudinally extending clamp 11 welded to the inside of the part near the edge 9. Clamp 11 has two arms 20, 21 at right angles, with arm 20 being welded to the second part 3 by a welding bead 22 as shown in FIGS. 6 and 7.

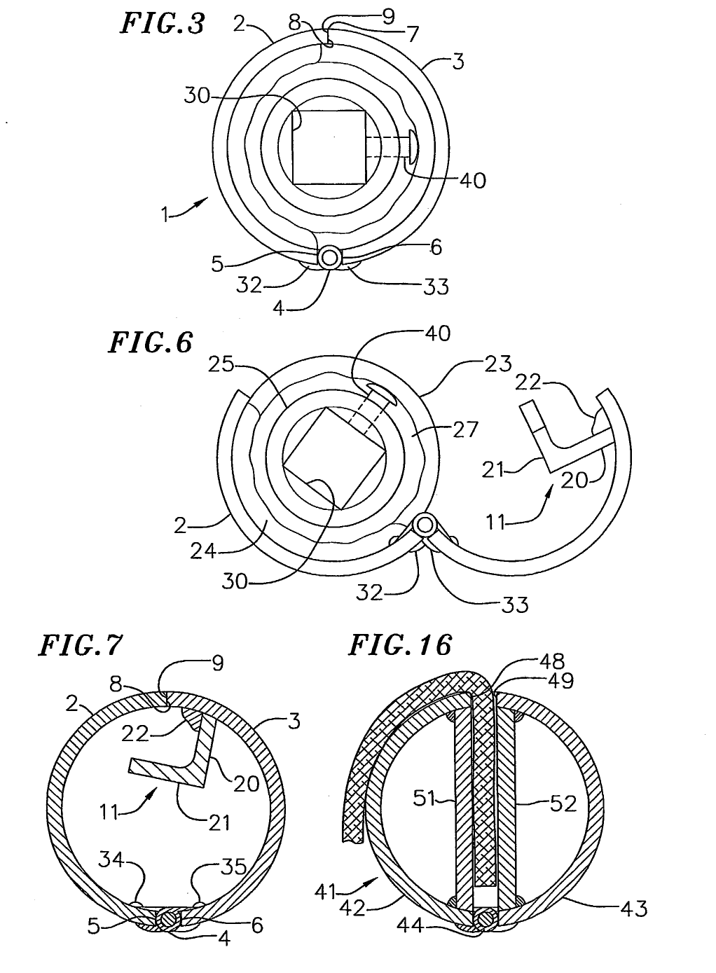

Roller 1 further includes solid discs 23 at each end of the roller for coupling or attaching a drive mechanism to the roller. The disc 23 is preferably made from a rigid material such as steel and is attached to the first part 2 by welding, as shown by weld bead 24 to form a closed end at each end of the cylinder. A coupler 25 for connecting the roller to a drive mechanism is attached to the disc 23 by a weld bead 27. The coupler 25 has a hole 30 that has a selected shape, such as a square, as shown in FIGS. 3 and 6.

The hinge 4 is a continuous longitudinal hinge, similar to a piano hinge, and is welded to the first part 2 and the second part 3 as shown in FIG. 2 by the weld spots 32 on part 2 and the weld spots 33 on part 3. The hinge 4 is also welded internally and is welded to the first part 2 by weld spots 34 and to the second part 3 by weld spots 35, as shown in FIG. 4.

The coupler 25 has a pin 40 that extends into the hole 30 to secure the drive mechanism in place when in position on the tool. The coupler 25, as best seen in FIGS. 1, 2, 4, and 5 extends out beyond the cylindrical portion of the tool for attachment to the drive mechanism.

In operation, the two parts of the tool are separated a sufficient distance to permit the insertion of the end or edge of the floor covering to be pulled up by the tool. The tool is then closed, as shown in FIG. 8, with the edge or end 51 of the floor covering 50 in the tool. The clamp 11 pushes the end 51 towards the interior surface of the first part 2 of the tool to hold the end of the floor covering in place. The roller 1 is then rolled to pull up the floor covering 50 from the substrate 52 to which it has been adhesively attached. As the roller 1 is rotated, the floor covering is pulled up and is rolled onto the roller as shown in FIG. 9.

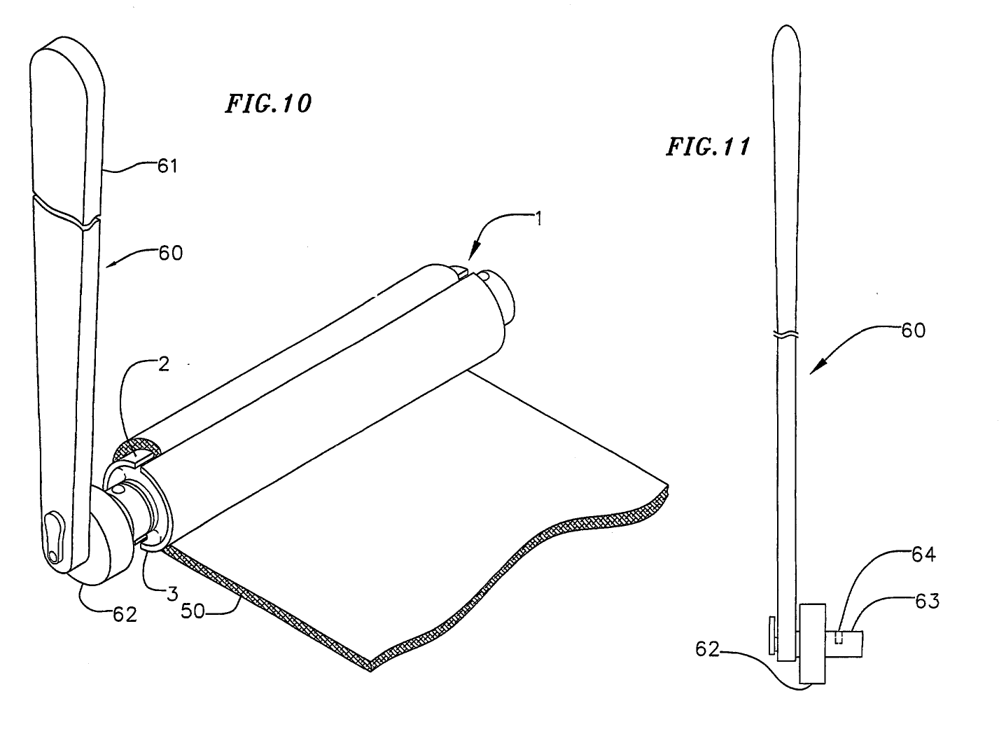

A manual drive mechanism for rotating the roller 1 is shown in FIGS. 10 and 11. The manual drive mechanism 60 includes a lever arm 61 and a ratchet housing 62 containing a typical ratcheting mechanism to permit positive drive in either direction. The manual drive mechanism 60 further includes a shaft 63 that has an external configuration that corresponds to the configuration of the hole 30 in the roller 1. The shaft 63 has an indentation or a hole 64 in which the pin 40 is inserted for holding the mechanism in position on the roller 1.

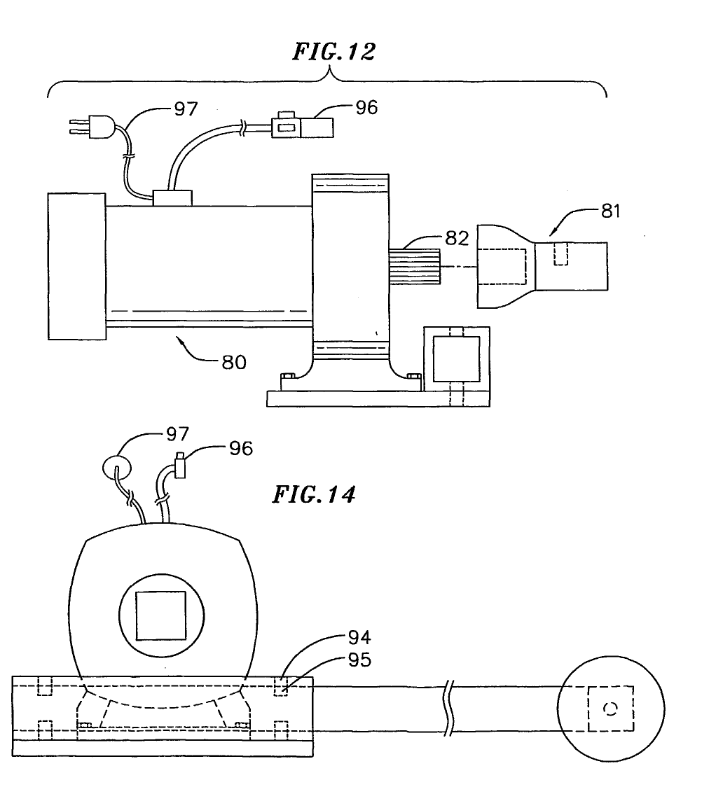

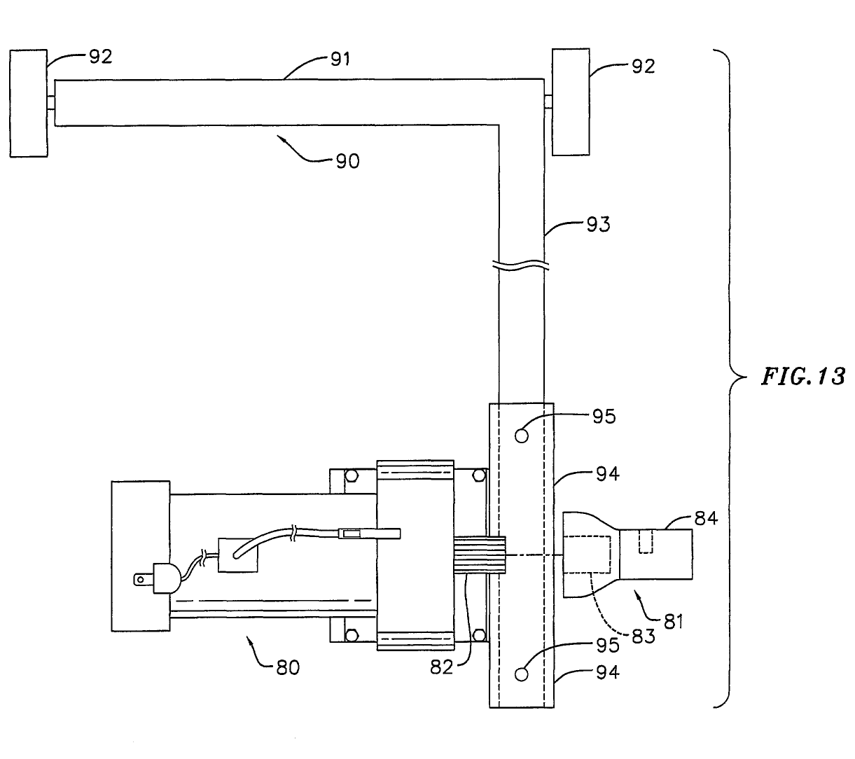

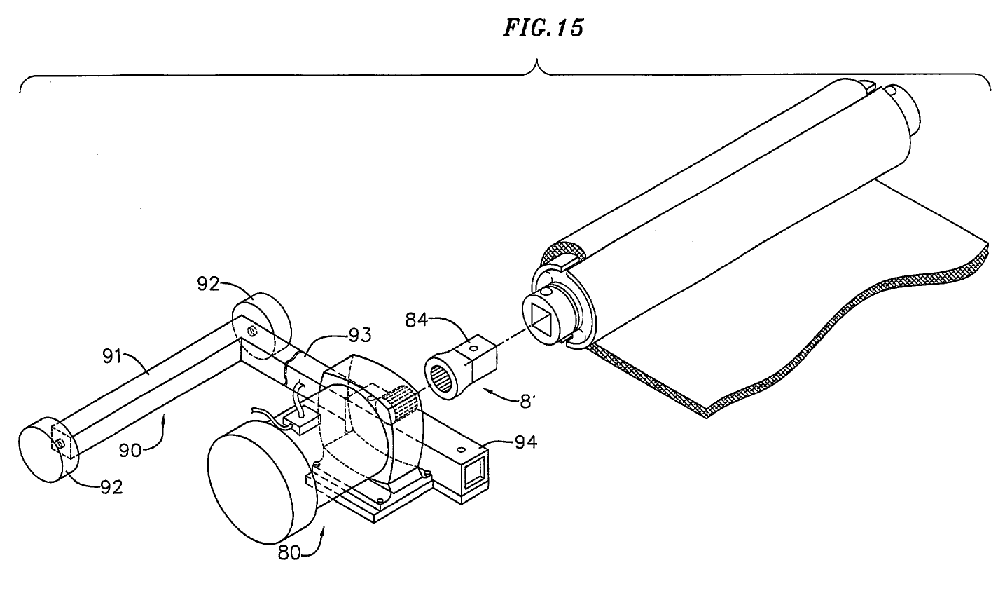

The roller may also be rotated by a motorized drive mechanism as shown in FIGS. 12 through 15. A motor 80 is coupled to the roller 1 through an adapter 81. The motor 80 may advantageously be a ⅓ hp motor manufactured by Dayton and sold by Grainger. The motor is a split phase TEFC 115 volt 60-cycle motor having stock no. 6Z402. The motor shaft 82 is knurled and fits in a corresponding hole 83 of the adapter 81. Adapter 81 has a further extension of a shaft 84 that fits in the hole 30 of the roller 1.

A wheeled carriage 90 supports motor 80 on one side of the motor so that as the motor rotates the roller 1 and the roller and motor move in one direction, the wheeled carriage 90 moves with the motor 80 and supports the motor. The motor 80 is also supported at the shaft end through the adapter 81 and the roller 1. The carriage 90 has a first square bar 91 that supports a wheel 92 at each end. A second square bar 93 at a right angle to bar 91 extends into a holder 94 that is attached to the motor 80. The bar 93 has a pair of holes 95 for insertions of pins to hold the wheeled carriage in the holder 94 attached to the frame of motor 80.

A hand held switch 96 extends from the motor 80 for operation of the motor. The motor is coupled to an AC outlet through an electrical cord 97.

An alternative embodiment for the roller is shown in FIG. 16. A roller 41 includes a clamp 70, for holding the end of the floor covering, such as carpet, in place for removal. The clamp consists of two longitudinal plates 71 and 72 inside the roller 41. Plate 71 extends the length of a first part 42, that is essentially one-half of a cylinder. Plate 71 is attached internally to the first part 42 near a longitudinal edge 48 along one side and is attached internally to the first part near a hinge 44 along the other side to cover the open face of the first part 42. Similarly, plate 72 extends the length of a second part 43, that is essentially one-half of a cylinder. Plate 72 is attached internally to the second part 43 near a longitudinal edge 49 along one side and is attached internally to the second part near the hinge 44 along the other side to cover the open face of the second part.

The plates 71 and 72 are flat and their surfaces are essentially parallel, when the first part 42 and second part 43 are in their fully closed position, similar to the roller 1 as shown in FIGS. 1-3.

These plates may be angled in their attachment to be closer near the hinge 44 when closed or farther apart as compared to the spacing when the plates are parallel. The spacing is determined by the thickness of the floor covering, such as carpet or vinyl, to be removed.

The plates are steel plates and add rigidity to the tool. As a consequence, the parts 42 and 43 may be made of lighter material than the tool of FIGS. 1-7.

The rigidity of the tool is important in operation. Some material, such as plastics, like PVC, may twist and/or break if the tool is caused to turn by force applied at only one end. A rigid tool, such as one made of a sufficiently thick metal or one having rigid partitions and a rigid outer body as shown in FIG. 16 will have minimal twist and can be caused to turn or rotate by force applied at only one end. One problem with a roller that twists is that the floor covering does not go on the roller straight, but skews and interferes with the drive mechanism.

A preferred metal is steel; but other metals, such as aluminum, if sufficiently thick to be rigid and not twist, may also be used.

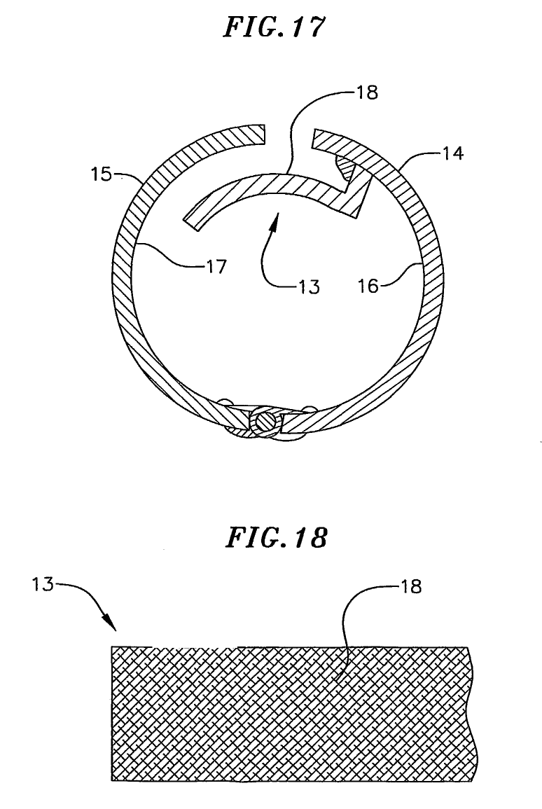

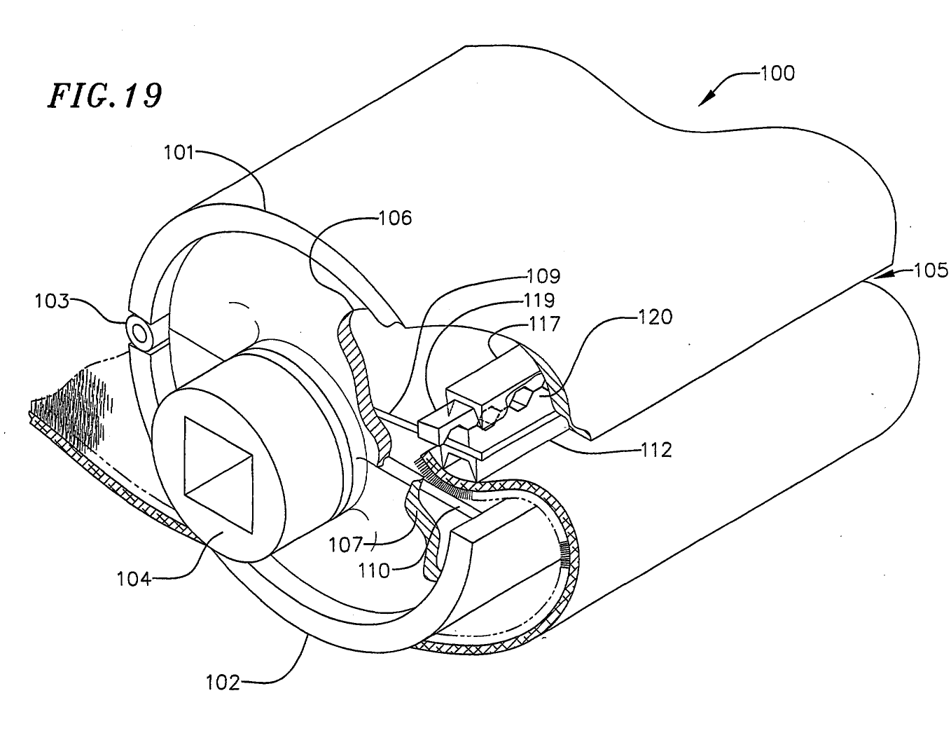

Another embodiment, shown in FIGS. 17 and 18 of the drawings, has a clamp 13 that is welded to the inside surface 16 of the first part 14. The clamp 13 has a surface 18 that is curved with a curve that matches the curve of the inside surface 17 of the second part 15. The curved surface 18 is rough, as shown in FIG. 18, to better grip the floor covering. The curved surface 18 holds the end of the floor covering, such as carpet, between the curved surface 18 of the clamp 13 and the inner curved 17 surface of the second part 15.

The surfaces of the clamps such as clamps 11, 13 and 70 of the various rollers of this invention may be smooth or rough. Further, the clamp may not cover the full longitudinal length of the roller. For example, clamp 70 of FIG. 16 may have a plurality of flat plates 71 and 72 of short length rather than single plates that extend the full longitudinal length of roller 41.

When the plates 71 and 72 extend the full longitudinal length of the roller 41, the internal curved surfaces of parts 42 and 43 are not exposed to the glues that may adhere to the floor covering inserted in the roller. Further, the parts 42 and 43 of roller 41 may be completely sealed by separate end caps having a semi-circular shape that corresponds to the semi-circular shapes at the end of a part 42 or 43. As a consequence the roller is relatively easy to clean since only one surface of plates 71 and 72 is exposed to the glue.

The spacing between the part and the clamp or, between the surface of the holding mechanism in the roller is determined by the type and thickness of the floor covering to be removed. The spacing between plates 71 and 72 is less for vinyl, for example, than it is for carpet.

Common lengths for the roller are 1 foot, 2 feet and 4 feet. A common width for a floor covering, such as carpet, is 12 feet so that the floor covering can be cut into three four-foot strips and quickly and easily pulled up by a roller that is 4 feet long. The shorter rollers, such as a 1 foot roller, is useful in removing glued down floor covering from stairs and from small or confined areas. The operation of the floor covering removal tool is the same on stairs as in larger flat areas, such as a room. The end of the floor covering to be removed is inserted into the roller 1 and clamped in place by closing the two parts of the roller to form the cylindrical body and then the roller is rotated, preferably by use of the manual drive mechanism of FIGS. 10 and 11.

The application of the floor covering removal tool in an area where the floor covering is to be pulled up and removed requires a starting point, which may be any comer or against a wall. The floor covering, if wider than the longitudinal length of a tool, which is commonly four feet long, must be cut into strips of a selected width such as four feet. After cutting the floor covering into strips, the end of the floor covering against a wall or at the edge of the floor covering, is pulled up, usually by a manual means, a short distance to provide an end to be inserted into and gripped by the roller. As shown in FIGS. 8 and 9, the end 51 is inserted and the roller is rotated to begin the rolling of the floor covering onto the roller. The roller is rotated as many revolutions as desired in pulling up and rolling the floor covering onto the roller. The number of layers that may be rolled onto the roller is dictated by the strength of the roller, the strength of the floor covering, and/or the strength of the operator that is using the manual drive mechanism 60, or the strength of the motor if a motor is being used to drive the tool. When the limit is reached or there are as many layers as desired, the tool is backed off a short distance and the floor covering is cut near the tool to provide an end of the floor covering that may be inserted in the tool to start the next removal of floor covering.

To prepare for removing the next strip of floor covering, the tool 1 is rotated to unroll the layers of floor covering 50 from the tool so that it may be used on the next strip of floor covering. To avoid this time-consuming step of unrolling the floor covering from the tool, the tool is modified to have a variable diameter; a large diameter while the floor covering is being removed and rolled onto the tool, and a smaller diameter to permit removal of the tool or roller from the layers of rolled-up floor covering.

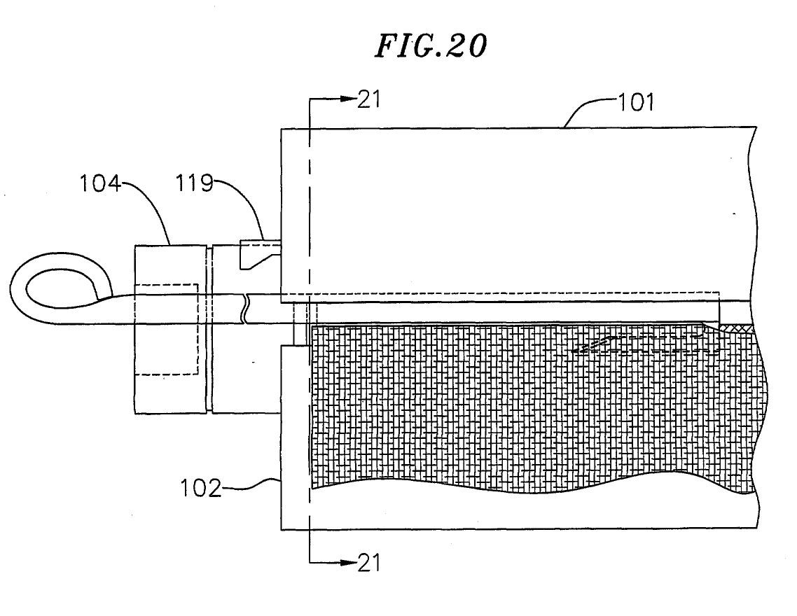

Such a tool is shown in FIGS. 19-26. As shown in FIGS. 19-23, the tool has a roller 100 made up of a first part 101 and a second part 102. The parts 101 and 102 are connected by a hinge 103. As shown in the drawing of FIGS. 19-23, the hinge 103 is diametrically opposite an opening 105 in the roller 100. The hinge 103 does not have to be diametrically opposite the opening 105 and can be offset as shown in FIG. 26. In this case, the first part 101 is smaller than the second part 102. It could be the other way around also where the second part 102 is smaller than the first part 101.

The roller 100 includes a coupler 104 at one end or at both ends to couple the roller 100 to a drive mechanism such as the manual drive mechanism 60 in FIG. 10 or the motor 80 in FIGS. 12-14. The first part 101 has an end plate 106 welded to the first part to give strength to the roller 100 and to keep foreign matter out of the interior of the roller 100. The second part 102 has an end plate 107 to give added strength to the roller 100 and to keep foreign matter out of the interior of the roller 100. Similar end plates (not shown in the drawings) are connected to the opposite end of the roller 100.

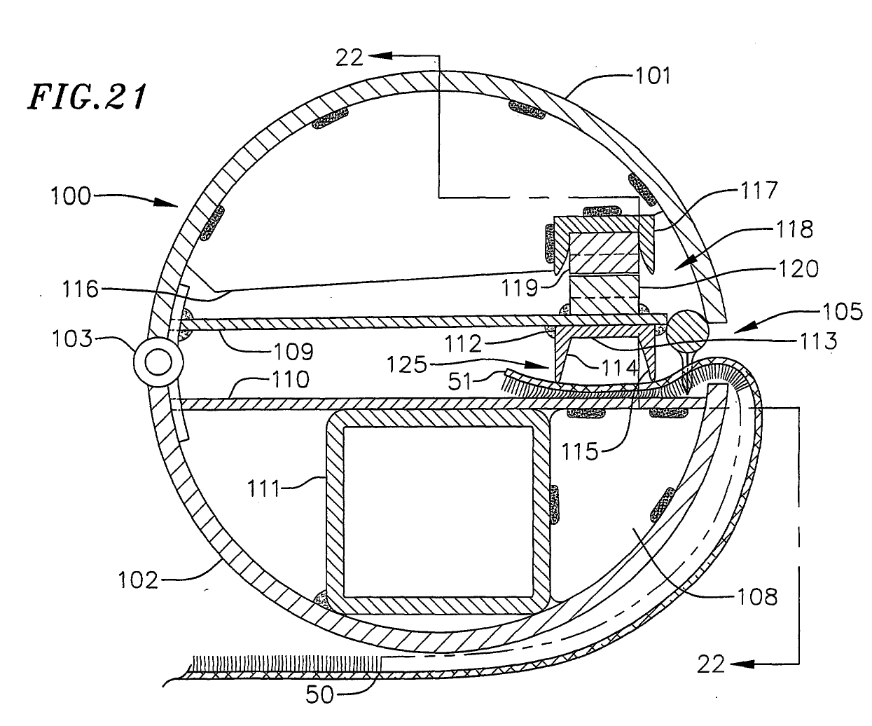

As best seen in the cross-sectional view of FIG. 21, a longitudinal plate 109 is welded to the interior wall of the first part 101 and partially extends across the open face of the interior of the first part 101 and stops near the edge of part 101 at the opening 105. A longitudinal plate 110 is welded to the interior surfaces of the second part 102 at both ends of the plate 110. Plate 110 extends the longitudinal length of the roller 100 inside the second part 102. Alternatively, the plates 109 and 110 may be made up of a plurality of plates that extend a selected distance within the roller 100 with spacing between the plates in the longitudinal direction. The plate 110 extends across the open interior of the second part 102 and being welded at both ends gives additional strength to the roller 100. To give added rigidity to the roller 100, a square tube 111 extends the longitudinal length of the first part 102 beneath the longitudinal plate 110 and is welded to the interior surface of the second part 102.

Additional strengthening partitions 108 are welded between the interior surface of the second part 102, the longitudinal plate 110, and the square tube 111, as shown in FIG. 21. Strengthening partition 116 are welded at longitudinal intervals inside the first part 101 as shown in FIG. 21.

The end of the floor covering 51 to be pulled up and removed is inserted in the opening 105 and is held in place by a gripper 125. Gripper 125 is made up of a channel bar 112 that cooperates with the strengthening plate 110 to grip the floor covering end 51 in the roller 100. Channel bar 112 has abase 113, a first leg 114 and a second leg 115. Legs 114 and 115 push the end of the floor covering 51 against the strengthening plate 110 to grip and hold the end of the floor covering in the roller 100. The channel bar 112 is welded to the underside of the strengthening plate 109 and is carried by this strengthening plate.

An adjustable spacer 118 is positioned between the top of strengthening plate 109 and a channel bar 117. The adjustable spacer 118 has a fixed member 120 and a movable member 119. Channel bar 117 acts as a guide and support for the movable member 119. Movable member 119 moves inside the U-shaped channel member 117 along the longitudinal direction of the roller 100.

As noted above, the rollers 100 may come in various lengths depending upon the location and type of floor covering to be removed. A typical length for glued-down carpeting is four feet. A four-foot roller, as shown in FIGS. 21-26, is made up of Schedule 10 steel pipe. Such pipe has a 4½ inch outside diameter and is called a four-inch pipe. The thickness of the walls is ⅛ inch so that in FIGS. 21-26, the first part 101 would have a wall thickness of ⅛ inch and the second part 102 would have a wall thickness of ⅛ inch. The longitudinal plate 110 is a ⅛-inch plate with holes in the plate and is known as “punch plate.” This plate, being welded to the first part 101 at only one end (or edge) flexes inside the roller 100. Longitudinal plate 109 is similarly constructed of ⅛-inch punch plate. The square tube 111 is made of a square tubing that has 1½ inch sides and is ⅛ inch thick. The square tube 111 may extend the longitudinal length of the roller 100 or may be made up of small pieces that are longitudinally spaced inside the second part 102. The strengthening partitions 108 or rib braces are ⅛ inch thick and four of these are positioned and equally spaced from the end plates 107 inside the second part 102. Strengthening plates 116 are ⅛-inch rib plates or braces and are equally spaced longitudinally between the end plates 106 of the first part 101.

The channel bar 117 that is part of the adjustable spacer 118 is welded to each of the strengthening partitions 116 of the second part 101. The tube parts 101 and 102 of the roller 100 are essentially semi-cylinders that when joined together by a hinge 103 forms a roller 100 that is essentially cylindrical in shape. It is noted that the roller 100 is not a true cylinder in operation because of the gripper 125 and adjustable spacer 118 that leaves an opening 105 between the two parts. The space between the first part 101 and the second part 102 at the opening 105 varies depending upon the position of the adjustable spacer 118.

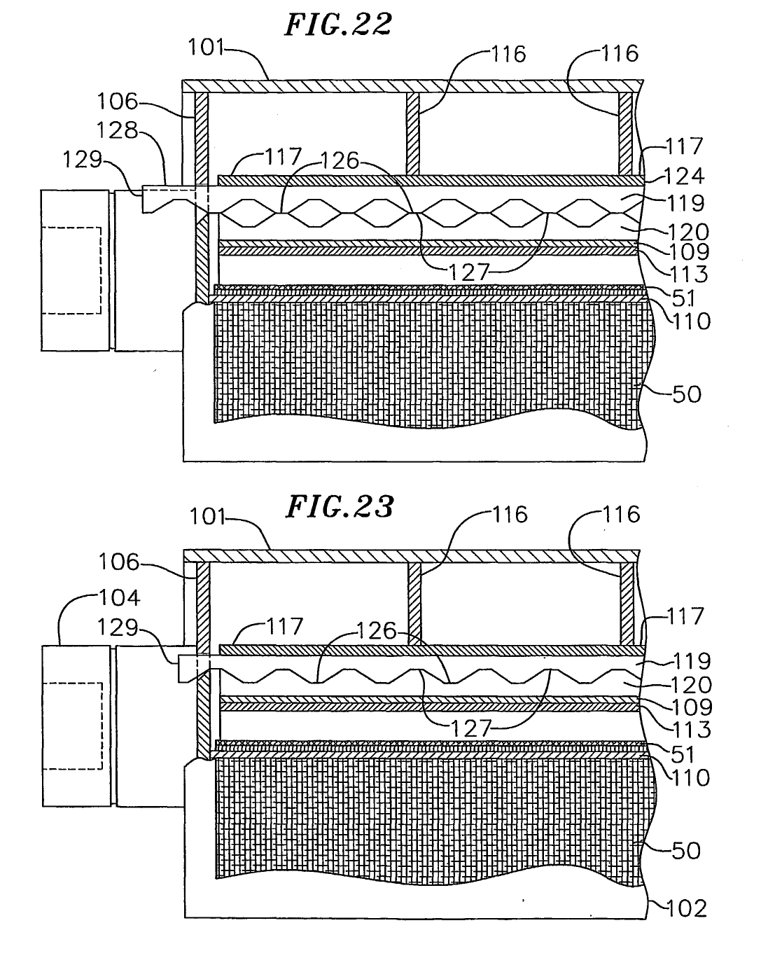

The adjustable spacer 118 is shown in greater detail in FIGS. 22 and 23. FIG. 22 is in partial cross section and is taken along the section line 22-22 of FIG. 21. In this view, the end plate 106 is shown in cross section as are the strengthening plates 116 of the first part 101. The base 124 of channel bar 117 is shown in cross section in FIG. 22. The movable member 119 and fixed or stationary member 120 of the adjustable spacer 118 is shown in elevation in FIG. 22. The strengthening plate 109 is shown in cross-section as is the base 113 of the channel bar 112. The end of a floor covering 51 is shown in cross-section as is the strengthening or longitudinal plate 110.

The movable member 119 has a row of teeth 126 while the fixed member 120 has a row of teeth 127. The teeth 126 and 127 have flat surfaces that mate, as shown in FIG. 22, to hold the first part 101 and the second part 102 apart from each other at a selected diameter for the roller 100. Movable member 119 has an extension 128 with a flathead 129. The flathead 129 is designed to be struck by an instrument, such as a hammer, to drive the movable member 119 to the right in FIG. 22. When the movable member 119 is driven to the right, the row of teeth 126 fall into the teeth of the row of teeth 127 so that the diameter of the roller is decreased. When the teeth 126 and 127 ride. on top of each other as shown in FIG. 22, they act as a shim to keep the first part 101 away from the second part 102. When the teeth 126 and 127 mesh, as shown in FIG. 23, the first part 101 and second part 102 move closer together and have a resultant smaller diameter for the cylinder of the roller 100.

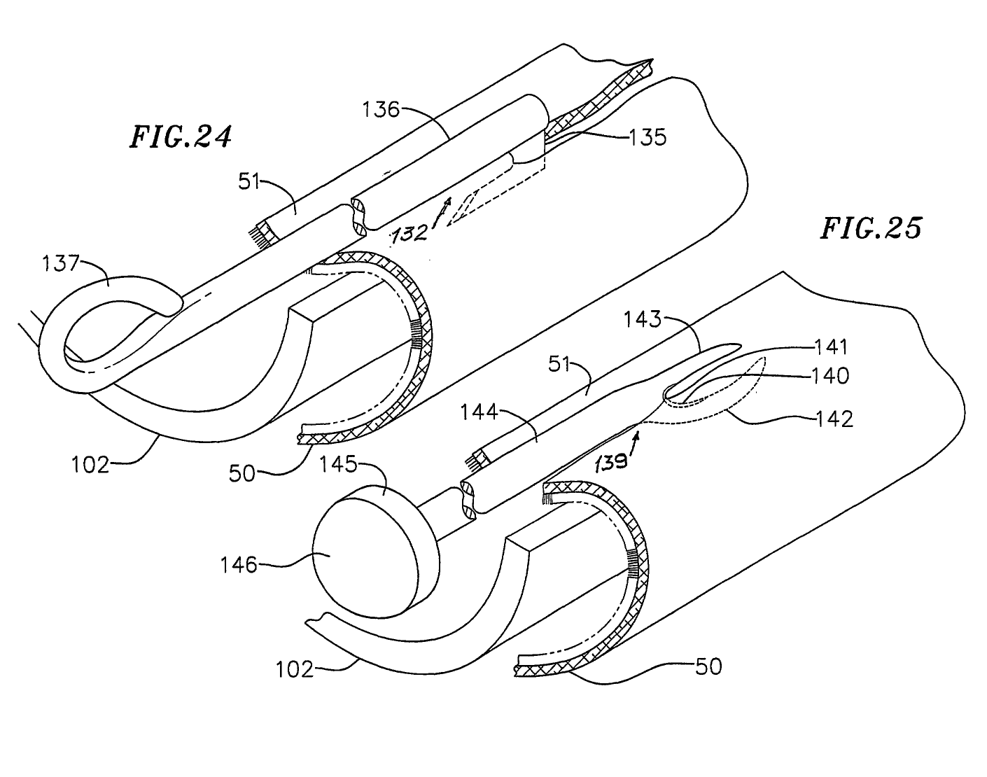

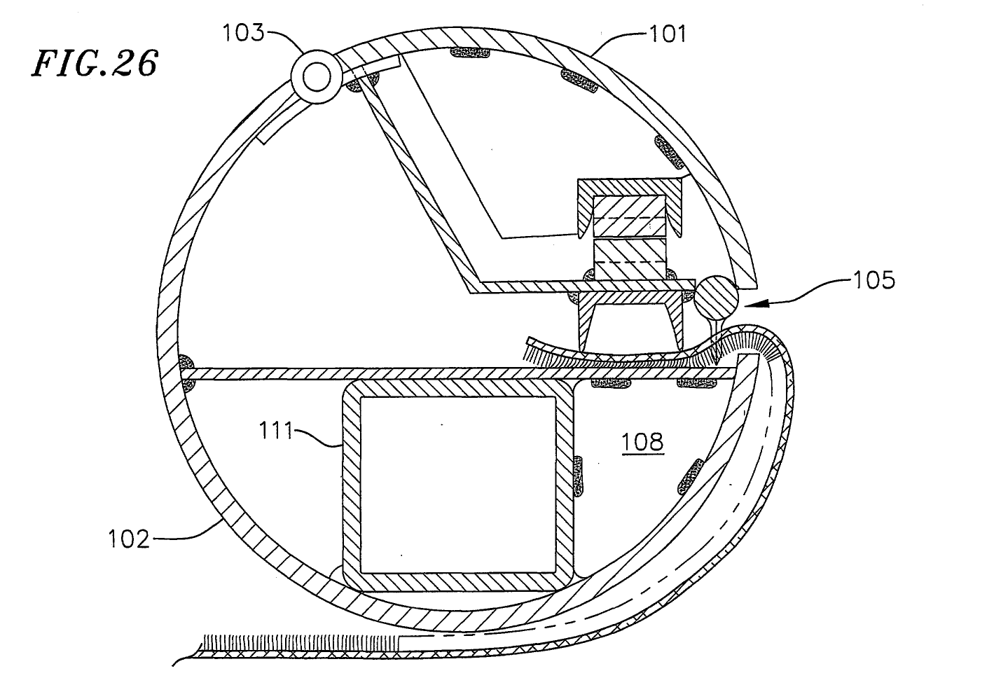

The floor covering in the roller 100 may be cut and separated from the floor covering rolled onto the roller by a knife 132 that is pulled, as shown in FIG. 24, or by a knife 139 that is pushed, as shown in FIG. 25. These knives are located and travel between the clamp 125 and opening 105. The knife of FIG. 24 that is pulled is positioned inside the roller 100 before the floor covering is rolled onto the roller in operation. The knife 132 has a blade 135 that is carried by a rod 136 which has the blade 135 connected at one end and a handle 137 connected at the opposite end. The handle 137 is gripped to pull the knife blade 135 through the roller 100 to cut the floor covering 50 for removal of the roller 100. When the desired number of layers have been rolled onto the roller 100 and it is desired to pull the roller 100 out of the layers of floor covering, it is cut as shown in FIG. 24. After the floor covering 50 is cut and separated from the clamped end 51 by pulling the blade through and out of the roller 100, the head 129 of movable member 119 is struck to move the member 119 so that the teeth mesh. This causes the diameter of the roller to be reduced so that the roller can be pulled and/or pushed out of the layers of floor covering that are around the roller 100.

It is noted that in the drawings of FIGS. 24 and 25 there is only a partial layer of floor covering 50 shown. However, in operation, there will be a plurality of layers or full rolls of floor covering. The partial one is shown for ease of illustration of the position and operation of the knife blade 135 for cutting the floor covering 50 and is not be limiting as to the number of rolls or layers before the knife of FIG. 24 or the knife of FIG. 25 is used.

An alternative embodiment of a knife for cutting the floor covering 50 is shown in FIG. 25. In this embodiment, the knife is pushed rather than being pulled through the roller 100. Also where the knife is pushed as shown in FIG. 25, the knife is not positioned inside the roller during the operation of the roller to pull up and remove the floor covering by rolling it onto the roller 100. The knife, as shown in FIG. 25, which is pushed into and through the roller 100, has a blade 140 that is shaped like a seam ripper used by seamstresses. The blade 140 has a center portion 141 that is sharp for cutting the floor covering 50. The blade 140 further includes a first leg 142 that rides under the floor covering 50 while cutting. This leg 142 is positioned between the clamp 125 and opening 105 and rides in the area where the plate 110 is welded to the second part 102 near opening 105. The blade 140 includes a second leg 143 that rides above the floor covering while cutting as shown in FIG. 25. The knife further includes a rod 144 that is connected to the blade 142 at one end and has a handle 145 with a push surface 146 at the opposite end. The rod 144 of knife 139 and rod 136 of knife 132 are small enough in diameter to easily move inside the roller 100 and are not as large as illustrated in FIG. 21. It is seen in FIG. 21 that in the area where the plate 110 joins the interior surface of the second part 102 near opening 105 there is a natural groove for the second leg 142 of knife 139 and for the lower part of blade 135 of knife 132.

Although preferred embodiments of the floor covering removal tool have been shown and described above, the invention is not limited to these specific embodiments, but rather the scope of the invention is to be determined as claimed.

What is claimed is:

1. A floor covering removal tool comprising a first part and a second part coupled together by a hinge to form a roller having a substantially cylindrical body with a longitudinal opening for insertion of an end of the floor covering to be removed, means for holding the end of the floor covering in place inside the cylindrical body, a coupler at least at one end of the cylindrical body for coupling the roller to a drive mechanism to roll the roller over the floor covering to be removed so that the floor covering rolls onto the roller.

2. A floor covering removal tool in accordance with claim 1 wherein the two parts are identical and have a shape of substantially hollow half cylinders.

3. A floor covering removal tool in accordance with claim 1 wherein the parts are made of metal and one part has an angled member attached to the inside surface with a protrusion extending toward the interior surface of the other part when the two parts are closed.

4. A floor covering removal tool in accordance with claim 1 wherein one part has a curved portion that is less than one-half of a hollow cylinder while the second part has a curved surface that is greater than one-half of a hollow cylinder.

5. A floor covering removal tool of claim 1 wherein the first part and the second part are of sufficiently rigid material to prevent twisting of the roller and skewing of the floor covering on the roller.

6. A floor covering removal tool in accordance with claim 1 wherein the holding means is attached to the second part and has a surface with a curvature that is the same as the interior surface of the first part, the curved surface being spaced apart from the interior surface of the first part by a distance determined by the type and thickness of the floor covering to be removed.

7. A floor covering removal tool in accordance with claim 6 wherein the curved surface of the holding means is rough to securely grip the end of the floor covering when the parts are closed to form the cylindrical body.

8. A floor covering removal tool comprising a roller having an essentially cylindrical outer body made of sufficiently rigid material so that the roller will not twist and will not skew the floor covering on the roller as the covering is rolled onto the roller and a means for clamping an end of the floor covering inside the cylindrical body.

9. A floor covering removal tool comprising a first part and a second part coupled together by a hinge to form a roller having a substantially cylindrical body, each part having an essentially half cylindrical shape with a longitudinal open face, means for holding the end of a floor covering internal of the cylindrical body, the holding means comprising a first plate attached to the first part to cover the open face of the first part and having a length nearly equal to the longitudinal length of the first part to form a partition across the first part and a second plate attached to the second part to cover the open face of the second part and having a length nearly equal to the longitudinal length of the second part to form a partition across the second part.

10. A floor covering removal tool in accordance with claim 9 wherein the material of the plates and the first and second part form a sufficiently rigid roller to minimize twisting of the roller to prevent skewing of the floor covering on the roller when the roller is driven from only one end.

11. A floor covering removal tool comprising a roller having a substantially cylindrical body with a longitudinal opening, a clamp internal of the roller to hold an end of the floor covering to be removed, and a knife movable internally in the roller between the clamp and the opening of the roller to cut and separate the end of the floor covering from floor covering rolled onto the roller.

12. The floor covering removal tool in accordance with claim 11 wherein the knife is positioned inside the roller before floor covering is rolled onto the roller in preparation for cutting the floor covering.

13. A floor covering removal tool in accordance with claim 11 wherein the knife is inserted into the roller after floor covering has been rolled onto the roller.

14. A floor covering removal tool comprising a roller having a substantially cylindrical body with a longitudinal opening and means for changing the diameter of the roller.

15. A floor covering removal tool in accordance with claim 11 further comprising means for changing the diameter of the roller.

16. A floor covering removal tool in accordance with claim 15 wherein the changing means comprises a movable member and a fixed member whereby when the movable member is in one position relative to the fixed member, the roller has a first diameter, and when the movable member is in a second position relative to the fixed member, the roller has a second diameter wherein the first diameter is greater than the second diameter.

17. A floor covering removal tool in accordance with claim 16 wherein the movable member has a row of teeth and the fixed member has a row of teeth, the rows of teeth having the same configuration and when one row of teeth rides on top of the other row of teeth, it provides the first position and when the one row of teeth meshes with the second row of teeth, it provides the second position.
